(19) United States
(12) Patent Application Publication
(10) Pub. No.: US 2020/0106234 A1
(43) Pub. Date: Apr. 2, 2020

(54) TRANSMISSION DEVICE AND OPTICAL AMPLIFIER

(71) Applicant: FUJITSU LIMITED, Kawasaki-shi (JP)

(72) Inventors: Takashi INOUE, Hanyu (JP); NOBORU IZUHARA, OTA (JP); Yoshinori TAKETANI, Kawasaki (JP); Wataru Takano, Osaka (JP)

(73) Assignee: FUJITSU LIMITED, Kawasaki-shi (JP)

(21) Appl. No.: 16/529,839

(22) Filed: Aug. 2, 2019

(30) Foreign Application Priority Data
Sep. 28, 2018 (JP) 2018-184508

(51) Int. Cl. H01S 3/067; H01S 3/131; G02B 6/02

(52) U.S. Cl. CPC H01S 3/06783; G02B 6/02042; H01S 3/131; H01S 3/06737

(57) ABSTRACT

A transmission device includes an input/output unit that inputs or outputs an optical signal, and an optical amplifier that amplifies the optical signal passing through an optical fiber by excitation light. The optical amplifier includes a fiber-bundle set that includes a plurality of fiber bundles each formed by winding the optical fiber, and a plate-shaped heating member that has one surface along which the fiber bundles are arranged, and the fiber bundles have mutually different winding radii and are concentrically arranged on the surface of the plate-shaped heating member.

### CROSS-REFERENCE TO RELATED APPLICATION

This application is based upon and claims the benefit of priority of the prior Japanese Patent Application No. 2018-184508, filed on Sep. 28, 2018, the entire contents of which are incorporated herein by reference.

### FIELD

The embodiment discussed herein is related to a transmission device and an optical amplifier.

### BACKGROUND

In recent years, demands for larger capacity and higher speed of optical communication systems are increasing along with the growth of the field of information communication due to, for example, the worldwide spread of the Internet. Generally, WDM (Wavelength Division Multiplexing) communication is employed in such optical communication systems.

In an optical communication system employing WDM communication, an optical amplifier that amplifies signals with different wavelengths all at once is used in a transmission device that transmits optical signals. An example of such an optical amplifier is an erbium doped fiber amplifier (EDFA). The EDFA can amplify light in a wavelength band (around 1550 nm) in which transmission loss in an optical fiber is the minimum, and assumes an important role. That is, in the optical communication system, it is possible to perform high-speed and large-capacity communication with the EDFA.

The property of an erbium doped fiber (EDF) used in the EDFA is deteriorated depending on temperature. Therefore, in a case of amplifying an optical signal with the EDFA, the temperature of the EDF is usually kept constant. By keeping the temperature of the EDF constant, it is possible to stable optical amplification, and to maintain the quality of high-speed and large-capacity communication. Retaining the temperature of the EDF is made by accommodating a fiber bundle formed by winding the EDF in a reel, for example, and heating the reel by a heater.

Patent Document 1: Japanese Laid-open Patent Publication No. 2005-142487

Patent Document 2: Japanese Laid-open Patent Publication No. 2005-210141

As described above, retaining the temperature of an EDF is sometimes performed while a fiber bundle is accommodated in a reel. Specifically, for example, as illustrated in FIG. 8, a plurality of fiber bundles 20 for different routes are accommodated in an annular reel 10, and the fiber bundles 20 are heated by a heater 30 that is in contact with a sidewall of the reel 10. When the reel is made of a high thermal-conductivity metal, the reel is entirely heated by the heat of the heater 30, so that the temperature of all the fiber bundles 20 accommodated in the reel 10 can be raised uniformly.

However, depending on the relation between the size of the reel 10 and the number of the fiber bundles 20, there is a problem that contact between the reel 10 and the fiber bundles 20 is unstable, and some fiber bundles are not sufficiently heated. That is, for example, if an internal space of the reel 10 that accommodates the fiber bundles 20 therein is too large, the positions of the fiber bundles 20 may be displaced in the internal space of the reel 10, resulting in change of the state of contact between the reel 10 and the fiber bundles 20. As a result, the temperature rise of the fiber bundles 20 becomes irregular and it becomes difficult to uniformly retain the temperature of the fiber bundles 20.

Further, even if the positions of the fiber bundles 20 are fixed, there is a case where some fiber bundles 20 not in direct contact with the reel 10 are not sufficiently heated, so that optical amplification may be unstable. Specifically, for example, in a cross section of the reel 10 illustrated in FIG. 9, the temperature of the fiber bundles 20 that are in direct contact with a wall surface of the reel 10 among the fiber bundles 20 accommodated in the reel 10 is raised by heat from the heater 30. On the other hand, for example, a fiber bundle 20a is not in direct contact with the wall surface of the reel 10. Therefore, in some cases, the fiber bundle 20a is not sufficiently heated and the temperature thereof does not reach a temperature at which a satisfactory property is obtained. As a result, stable optical amplification is not performed and high-speed and large-capacity communication is prohibited.

### SUMMARY

According to an aspect of an embodiment, a transmission device includes: an input/output unit that inputs or outputs an optical signal; and an optical amplifier that amplifies the optical signal passing through an optical fiber by excitation light. The optical amplifier includes a fiber-bundle set that includes a plurality of fiber bundles each formed by winding the optical fiber, and a plate-shaped heating member that has one surface along which the fiber bundles are arranged, and the fiber bundles have mutually different winding radii and are concentrically arranged on the surface of the plate-shaped heating member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a transmission device according to an embodiment;

FIG. 2 is an explanatory diagram of an optical amplification method (1);

FIG. 3 is an explanatory diagram of an optical amplification method (2);

FIG. 4 is an explanatory diagram of an optical amplification method (3);

FIG. 5 is an exploded view illustrating a configuration of a temperature retaining structure according to the embodiment;

FIG. 6 is another exploded view illustrating a configuration of the temperature retaining structure according to the embodiment;

FIG. 7 is a schematic diagram illustrating cross-sections of relevant parts of the temperature retaining structure;

FIG. 8 is a diagram illustrating an example of an exterior view of a reel; and

FIG. 9 is a schematic diagram illustrating a cross section of the reel.

### DESCRIPTION OF EMBODIMENTS

Preferred embodiments of the present invention will be explained with reference to accompanying drawings. The present invention is not limited to the embodiment.

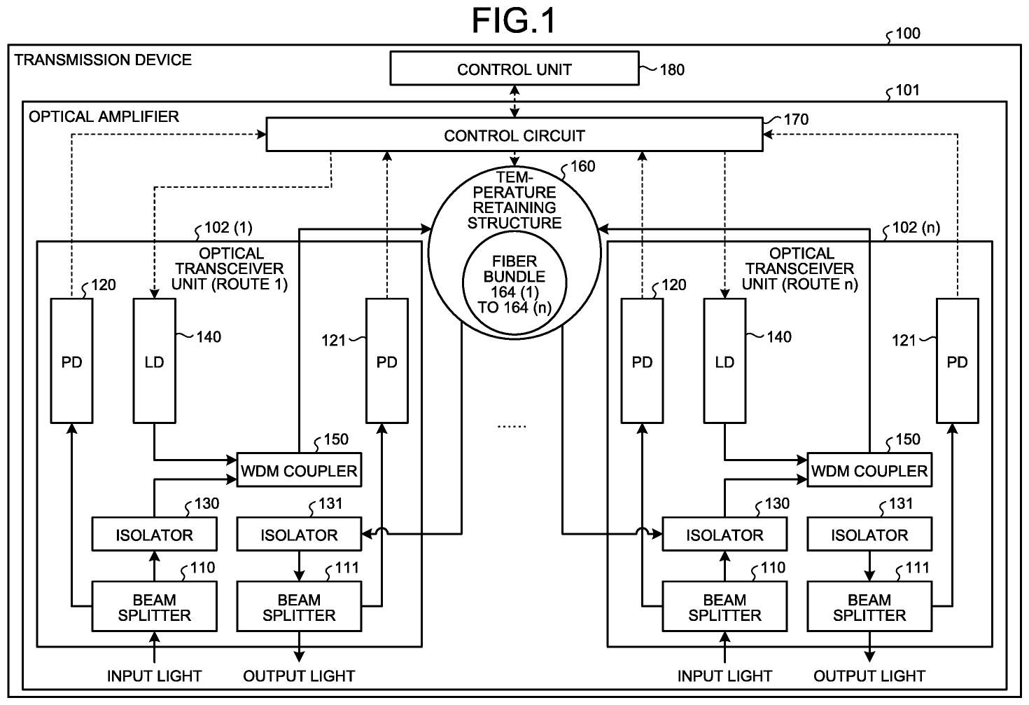

FIG. 1 is a diagram illustrating a configuration of a transmission device 100 according to an embodiment. The transmission device 100 is operated as a repeater that receives and optically amplifies an optical signal and then sends the optical signal. Note that the transmission device 100 may be also operated as a receiving device that receives an optical signal and optically amplifies the optical signal or a transmission device that sends an optically-amplified optical signal. Further, although not illustrated in FIG. 1, the transmission device 100 includes an input terminal to which a received optical signal is input, and an output terminal from which an optical signal to be sent is output. In FIG. 1, input and output of an optical signal are indicated with solid arrows, and input and output of an electric signal are indicated with broken arrows.

The transmission device 100 illustrated in FIG. 1 includes a control unit 180 that controls an electric signal and an optical amplifier 101 that amplifies an optical signal. The optical amplifier 101 includes a control circuit 170 that controls an electric signal, a temperature retaining structure 160, and optical transceiver units 102. The optical transceiver units 102 include optical transceiver units 102(1) to 102(n). Each of the optical transceiver units 102 includes beam splitters 110 and 111, photodiodes (hereinafter, abbreviated as “PDs”) 120 and 121, isolators 130 and 131, a laser diode (hereinafter, abbreviated as “LD”) 140, and a WDM coupler 150.

The beam splitter 110 splits an optical signal input from the input terminal of the transmission device 100 (hereinafter, “input light”) and outputs one of the obtained optical signals to the PD 120 and the other optical signal to the isolator 130. The beam splitter 111 splits an optical signal to be output from the transmission device 100 (hereinafter, “output light”), outputs one of the obtained optical signals to the PD 121, and outputs the other optical signal from the output terminal.

The PD 120 is a photodetector that detects the intensity of the optical signal output from the beam splitter 110. That is, the PD 120 detects the intensity of the input light. The PD 120 then notifies the control circuit 170 of the detected intensity of the input light. The PD 121 is a photodetector that detects the intensity of the optical signal output from the beam splitter 111. That is, the PD 121 detects the intensity of the output light. The PD 121 then notifies the control circuit 170 of the detected intensity of the output light.

The isolators 130 and 131 block returning light that returns due to, for example, reflection of an optical signal. That is, the isolator 130 prevents the input light that is output from the beam splitter 110 and is to be input to the WDM coupler 150 from returning to the beam splitter 110. The isolator 131 prevents the output light that is output from the temperature retaining structure 160 and is to be input to the beam splitter 111 from returning to the temperature retaining structure 160.

The LD 140 is a light source that emits excitation light with a wavelength for exciting an RDF provided in the temperature retaining structure 160. Specifically, the LD 140 emits excitation light with a wavelength of 980 nm, for example. While the excitation light is light with a wavelength of 980 nm, an optical signal is light in a 1550-nm band with little transmission loss in an EDF.

The WDM coupler 150 couples the input light output from the isolator 130 and the excitation light output from the LD 140 to each other, and inputs obtained coupled light to the temperature retaining structure 160. That is, the WDM coupler 150 inputs both the optical signal and the excitation light that are different in wavelength from each other to the temperature retaining structure 160.

The temperature retaining structure 160 includes a fiber-bundle set 164 including a plurality of fiber bundles 164(1) to 164(n) having different diameters from each other. Each of the fiber bundles 164(1) to 164(n) is a bundle of an optical fiber that is wound multiple times. Specifically, each of the fiber bundles 164(1) to 164(n) is formed by, for example, winding an erbium doped fiber (EDF) to form a bundle. The fiber-bundle set 164 includes the fiber bundles 164(1) to 164(n) for different routes, for example. Further, the fiber-bundle set 164 may include a plurality of fiber bundles 164(1) to 164(n) for one route mutually connected in series. In any case, diameters (ring diameters) around which the fiber bundles 164(1) to 164(n) included in the fiber-bundle set 164 are respectively wound are different from each other, and it is possible to arrange these fiber bundles 164(1) to 164(n) in a plane in such a manner that they do not overlap on each other.

The optical amplifier 101 excites an EDF in the temperature retaining structure 160 by excitation light to optically amplify an optical signal. Further, the temperature retaining structure 160 heats the fiber-bundle set 164 by a heater to be described later, thereby making the property of the fiber-bundle set 164 close to a desired property. That is, the temperature retaining structure 160 optically amplifies an optical signal by allowing the optical signal and the excitation light to pass through the EDF while the fiber-bundle set 164 is heated to a predetermined temperature by the heater. At this time, while the fiber-bundle set 164 includes the fiber bundles 164(1) to 164(n), the fiber bundles 164(1) to 164(n) are arranged concentrically on a plate-shaped heating member. With this configuration, a plurality of fiber bundles 164(1) to 164(n) are uniformly heated, so that stable optical amplification is realized. A specific configuration of the temperature retaining structure 160 will be described later in detail.

The control circuit 170 includes, for example, a CPU (Central Processing Unit), an FPGA (Field Programmable Gate Array), or a DSP (Digital Signal Processor), and controls the whole optical amplifier 101 in an integrated manner. Further, the control circuit 170 is connected to the control unit 180 of the transmission device 100, and sends and receives information or the like thereto and therefrom. Specifically, the control circuit 170 monitors whether an optical signal is normally input or output based on the intensity of the optical signal detected by the PD 120 or 121. Further, at the start of amplification of the optical signal by the temperature retaining structure 160, the control circuit 170 controls the heater included in the temperature retaining structure 160 to heat the fiber bundles 164(1) to 164(n) and causes the LD 140 to start emission of the excitation light.

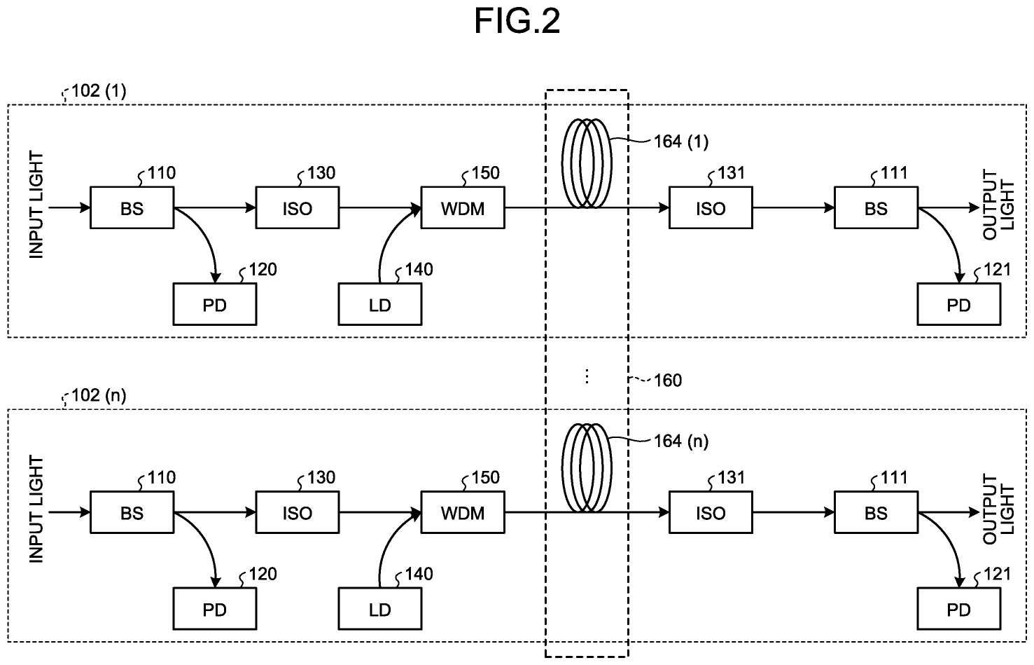

Next, a specific example of an optical amplification method in the transmission device 100 configured as described above is described with reference to FIGS. 2 to 4. FIG. 2 illustrates an optical amplification method in the transmission device 100 for, for example, CDC (Colorless, Directionless and Contentionless) transmission.

When an optical signal is input to the transmission device 100, input light is split by the beam splitter (“BS” in FIG. 2) 110, and one of the optical signals is output to the PD 120 and the other optical signal is output to the isolator (“ISO” in FIG. 2) 130. When the optical signal is input to the PD 120, the intensity of the optical signal is detected, and it is determined by the control circuit 170 whether input light with a normal intensity has been obtained.

The optical signal output to the isolator 130 is coupled to excitation light emitted from the LD 140 in the WDM coupler (“WDM” in FIG. 2) 150. The excitation light and the optical signal coupled to each other are optically amplified by the fiber bundles 164(1) to 164(n) provided in the temperature retaining structure 160. That is, when the excitation light and the optical signal pass through an EDF that configures the fiber bundles 164(1) to 164(n), the EDF is excited by the excitation light and raises the energy level of the optical signal.

The optically-amplified optical signal passes through the isolator 131 and is then output to the beam splitter 111. Thereafter, the output light is split by the beam splitter 111, and one of the optical signals is output to the PD 121 and the other optical signal is output from the transmission device 100. When the optical signal is input to the PD 121, the intensity of the optical signal is detected, and it is determined by the control circuit 170 whether output light with a normal intensity has been obtained.

In this manner, the transmission device 100 amplifies input light by the temperature retaining structure 160 that uses an EDF, and outputs an amplified optical signal. The fiber bundles 164(1) to 164(n) (EDF) included in the temperature retaining structure 160 are respectively provided for routes corresponding to, for example, a source of the input light and a destination of the output light. That is, the temperature retaining structure 160 includes the fiber bundles 164(1) to 164(n) (EDF) for different routes and amplifies optical signals for the respective routes.

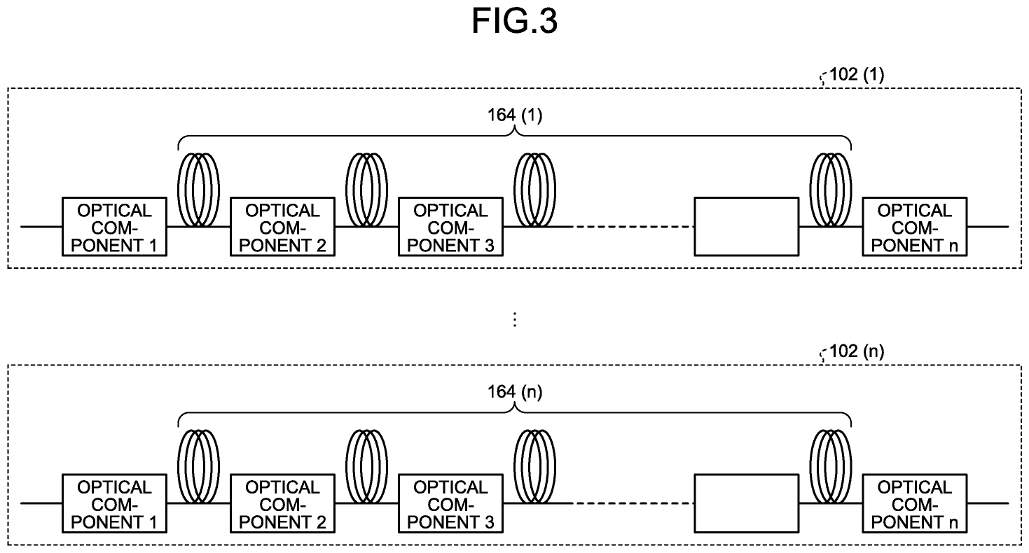

Next, FIG. 3 illustrates an optical amplification method in the transmission device 100 for, for example, a RODAM (reconfigurable optical add/drop multiplexer). Also in FIG. 3, similarly to FIG. 2, the optical amplifier 101 includes the optical transceiver units 102(1) to 102(n) for different routes. Unlike the configuration in FIG. 2, in the transmission device 100 of a RODAM type, each of the fiber bundles 164(1) to 164(n) (EDF) that performs optical amplification includes a plurality of fiber bundles mutually connected in series. The plurality of fiber bundles 164(1) to 164(n) (EDP) are accommodated in one temperature retaining structure 160. That is, the temperature retaining structure 160 includes the fiber bundles 164(1) to 164(n) each including fiber bundles mutually connected in series.

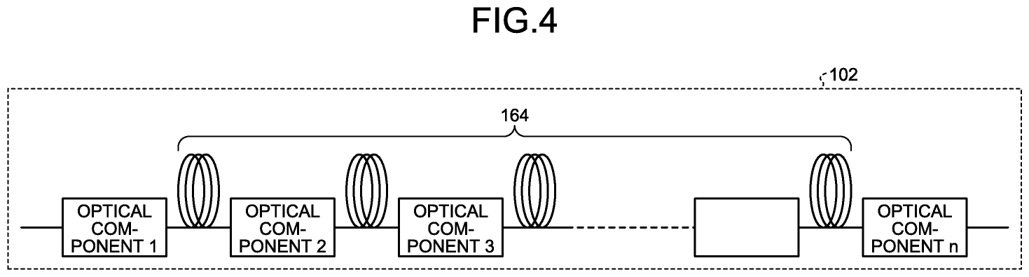

Further, FIG. 4 illustrates another optical amplification method in the transmission device 100 for, for example, a RODAM (reconfigurable optical add/drop multiplexer), where the method being different from that in FIG. 3. While the transmission device 100 in FIG. 3 includes the optical transceiver units 102(1) to 102(n), the transmission device 100 in FIG. 4 only includes one optical transceiver unit 102. Therefore, the fiber-bundle set 164 includes a plurality of fiber bundles mutually connected in series in one optical transceiver unit 102.

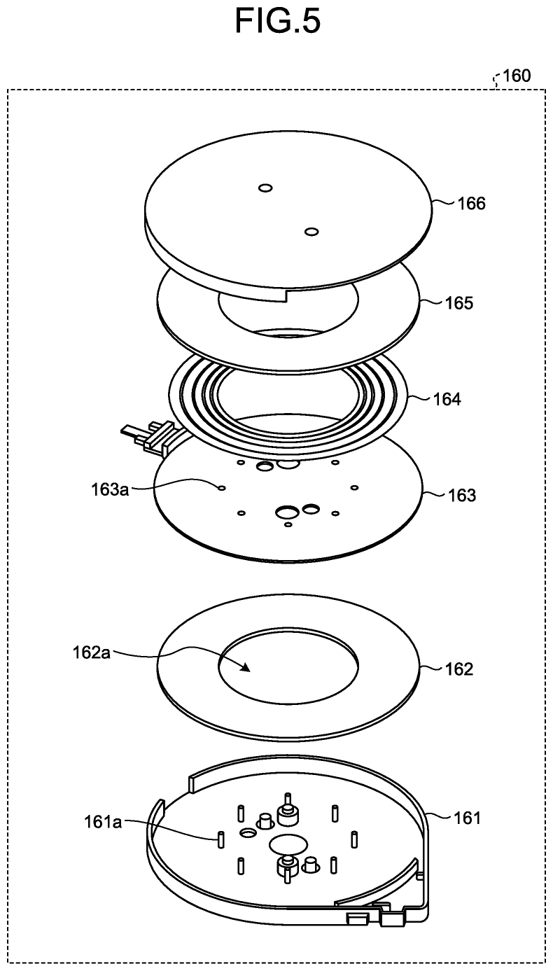

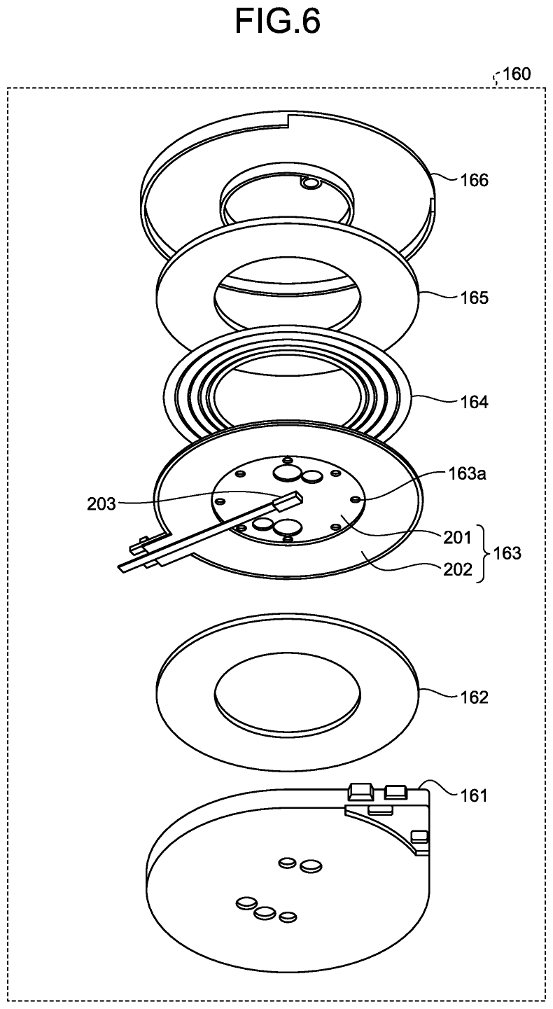

The configuration of the temperature retaining structure 160 is specifically described below with reference to FIGS. 5 and 6.

FIGS. 5 and 6 are exploded views illustrating a configuration of the temperature retaining structure 160 according to the present embodiment. FIG. 5 is an exploded perspective view as the temperature retaining structure 160 is viewed from above, and FIG. 6 is an exploded perspective view as the temperature retaining structure 160 is viewed from below. The temperature retaining structure 160 illustrated in FIGS. 5 and 6 includes a case member 161, a first heat insulating member 162, a plate-shaped heating member 163, the fiber-bundle set 164, a second heat insulating member 165, and a cover member 166.

The case member 161 is a case that can accommodate therein the first heat insulating member 162, the plate-shaped heating member 163, the fiber-bundle set 164, and the second heat insulating member 165. As described later, it suffices that the depth of the case member 161 corresponds to the height of one fiber bundle, because the fiber bundles 164(1) to 164(n) are arranged concentrically without overlapping on each other in the present embodiment. Further, the case member 161 that accommodates the fiber-bundle set 164 therein has an accommodating portion that is substantially cylindrical, because each of the fiber bundles 164(1) to 164(n) is formed to be annular by winding an EDF.

As illustrated in FIG. 5, a plurality of protrusions 161a are formed on a bottom surface of the accommodating portion of the case member 161. The protrusions 161a protrude above the plate-shaped heating member 163 through an opening 162a at the center of the first heat insulating member 162 and respective through holes 163a provided in the plate-shaped heating member 163, and define the smallest winding radius of the fiber bundles 164(1) to 164(n) (EDF) that configure the fiber-bundle set 164. That is, the fiber bundles 164(1) to 164(n) are each formed by an EDF wound around the protrusions 161a, thereby ensuring the smallest radius of a fiber bundle suitable for optical amplification.

The first heat insulating member 162 is an annular heat insulating material with the opening 162a formed at its center. The first heat insulating member 162 suppresses radiation of heat to be generated in the plate-shaped heating member 163 toward the case member 161.

The plate-shaped heating member 163 is a plate-shaped member that generates heat in accordance with control by the control circuit 170, and heats the fiber-bundle set 164 arranged on its upper surface. The through holes 163a that allow penetration of the respective protrusions 161a of the case member 161 therethrough are provided in the plate-shaped heating member 163.

As illustrated in FIG. 6, the plate-shaped heating member 163 is formed by attaching an annular heater 202 to a lower surface of a circular metal plate 201. A temperature measuring element 203 is placed at the center of the lower surface of the metal plate 201. Although it is desirable to place the temperature measuring element 203 at the center of the lower surface of the metal plate 201 from the viewpoint of making the temperature uniform, the shape of the heater 202 and the placed position of the temperature measuring element 203 are not limited to those illustrated in FIG. 4. That is, the heater 202 may be circular instead of being annular, as long as it can uniformly heat the metal plate 201, and the temperature measuring element 203 may be placed at a position deviated from the center of the lower surface of the metal plate 201, as long as it can accurately measure the temperature of the metal plate 201.

The metal plate 201 is a plate with a thickness of 0.1 to 0.5 mm, for example, made of a high thermal-conductivity metal such as aluminum or copper. In the metal plate 201, the through holes 163a are provided at positions corresponding to the protrusions 161a, respectively. The metal plate 201 transfers heat generated by the heater 202 to the fiber-bundle set 164 arranged on its upper surface, so as to heat the fiber-bundle set 164. While the upper surface of the metal plate 201 may be a smooth surface, by providing convex and concave portions or a number of minute protrusions in the upper surface of the metal plate 201, it is possible to increase friction in order to prevent displacement of each of the fiber bundles 164(1) to 164(n).

The heater 202 generates heat due to electric resistance, for example, in accordance with control by the control circuit 170. The width in a radial direction of the annular heater 202 corresponds to the width of a region of the upper surface of the metal plate 201 in which the fiber-bundle set 164 can be arranged. Further, the shape of the heater 202 may be identical to those of the first heat insulating member 162 and the second heat insulating member 165. That is, the heater 202 may be annular to surround the protrusions 161a. This configuration enables the protrusions 161a to prevent displacement of the heater 202.

The temperature measuring element 203 is placed at the center of the lower surface of the metal plate 201 to be in contact therewith, and measures the temperature of the metal plate 201. The temperature measured by the temperature measuring element 203 is notified to the control circuit 170, and the control circuit 170 controls the heater 202. In this manner, the temperature of the metal plate 201 can be adjusted.

The metal plate 201 is made of a high thermal-conductivity metal, and thus the center of the metal plate 201 that is not in direct contact with the heater 202 has approximately the same temperature as a portion that is in direct contact with the heater 202. Further, because the heater 202 is formed to be annular and is attached to the lower surface of the metal plate 201, it is possible to place the temperature measuring element 203 at the center of the lower surface of the metal plate 201, so that any component that interferes with the fiber-bundle set 164 is not arranged on the upper surface of the metal plate 201.

The fiber-bundle set 164 is formed by the fiber bundles 164(1) to 164(n) for different routes. That is, the fiber bundles 164(1) to 164(n) are formed by winding a plurality of EDFs for different routes to have different winding radii, respectively, and the fiber-bundle set 164 is formed by arranging the fiber bundles 164(1) to 164(n) having the different winding radii concentrically without causing them to overlap on each other. The fiber bundles 164(1) to 164(n) arranged concentrically are placed on the upper surface of the plate-shaped heating member 163 and are heated. The EDF of each of the fiber bundles 164(1) to 164(n) amplifies an optical signal by using excitation light input from the WDM coupler 150 and outputs the amplified optical signal to the isolator 131.

All the fiber bundles 164(1) to 164(n) are in direct contact with the upper surface of the plate-shaped heating member 163 because the fiber bundles 164(1) to 164(n) included in the fiber-bundle set 164 are concentrically arranged without overlapping on each other. As a result, all the fiber bundles 164(1) to 164(n) are uniformly heated, and property deterioration in EDFs caused by insufficient heating does not occur. In other words, optical amplification can be performed stably in all the fiber bundles 164(1) to 164(n). Further, because it is possible to retain the temperature of the fiber-bundle set 164 stably, wasteful power consumption can be prevented, and low power consumption can be realized.

When the fiber bundles 164(1) to 164(n) are arranged concentrically, the winding radii of the EDFs may be determined depending on the lengths of the EDFs for different routes. That is, by forming a fiber bundle to have a larger winding radius as an EDF is longer, the number of windings of the EDF is uniform in the fiber bundles 164(1) to 164(n), so that the cross-sectional sizes of the fiber bundles 164(1) to 164(n) can be made approximately the same. As a result, it is possible to uniformly heat the fiber bundles 164(1) to 164(n) respectively formed by a plurality of EDFs with different lengths. Further, if the cross-sectional sizes of the fiber bundles are different from each other, by setting the cross-sectional size of a fiber bundle arranged on an outer concentric circle larger than the cross-sectional size of a fiber bundle arranged on an inner concentric circle, it becomes possible for the fiber bundle arranged on the outer concentric circle to confine heat to the inside thereof, so that the temperature decrease caused by heat radiation to the side can be suppressed.

The second heat insulating member 165 is an annular heat insulating material with an opening formed at its center, similarly to the first heat insulating member 162. The second heat insulating member 165 suppresses radiation of heat generated in the plate-shaped heating member 163 toward the cover member 166. Further, the plate-shaped heating member 163 and the fiber-bundle set 164 are sandwiched between the first heat insulating member 162 and the second heat insulating member 165. This configuration can improve heat-insulating effect. Further, as the second heat insulating member 165 presses the fiber-bundle set 164 from above, it is possible to prevent the fiber-bundle set 164 from lifting from the upper surface of the plate-shaped heating member 163, thereby realizing stable heating of the fiber-bundle set 164.

The cover member 166 is a member that serves as a lid to cover a top of the accommodating portion of the case member 161. That is, the first heat insulating member 162, the plate-shaped heating member 163, the fiber-bundle set 164, and the second heat insulating member 165 are accommodated in a space between the cover member 166 and the case member 161. The cover member 166 may be locked by the case member 161 to be fixed thereto, or may be fixed to the case member 161 by a fixing member such as a screw.

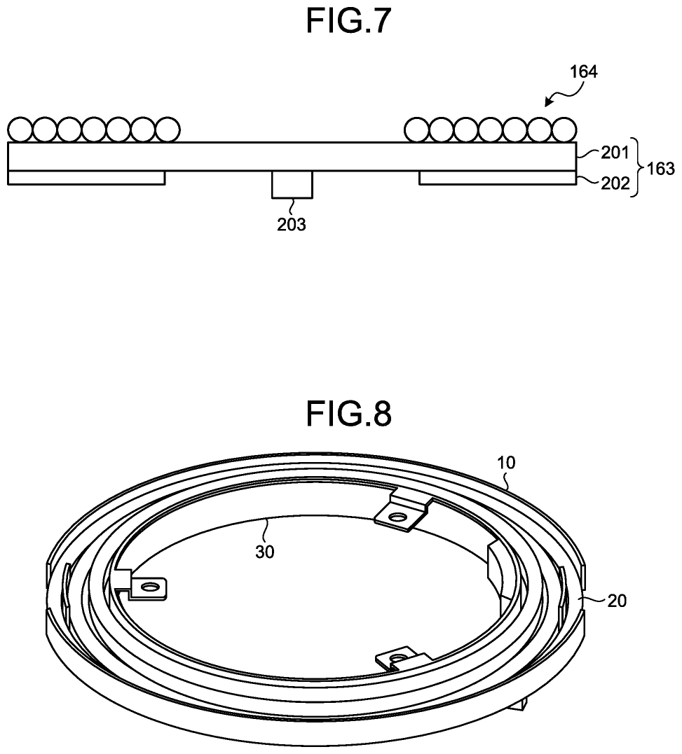

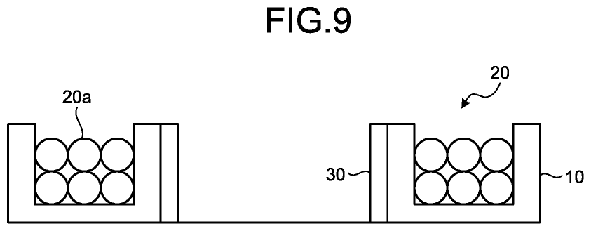

FIG. 7 is a schematic diagram illustrating cross-sections of the plate-shaped heating member 163 and the fiber-bundle set 164 of the temperature retaining structure 160. As illustrated in FIG. 7, a plurality of fiber bundles are arranged concentrically on an upper surface of the metal plate 201. Therefore, all the fiber bundles are in direct contact with the metal plate 201 and are heated by the heater 202 attached to a lower surface of the metal plate 201. As a result, all the fiber bundles are heated uniformly, and even if the temperature retaining structure 160 is started at a low temperature, for example, it is possible to heat the fiber-bundle set 164 to a predetermined temperature within a defined time. Further, property deterioration in EDFs caused by insufficient heating does not occur, and thus stable optical amplification can be realized in all the fiber bundles. Further, because it is possible to retain the temperature of the fiber-bundle set 164 stably, wasteful power consumption can be prevented, and low power consumption can be realized.

Further, because the heater 202 is annular, the temperature measuring element 203 can be placed at the center of the lower surface of the metal plate 201, so that it is possible to perform temperature control without causing any interference between the fiber-bundle set 164 and other components on the upper surface of the metal plate 201. Further, when a new fiber bundle is added to the fiber-bundle set 164 or replacement of a fiber bundle is to be performed, because fiber bundles are arranged without overlapping on each other, it is possible to easily arrange the new fiber bundle or perform replacement.

As described above, according to the present embodiment, a plurality of fiber bundles for different routes are arranged concentrically without overlapping on each other on one surface of a plate-shaped heating member to configure a temperature retaining structure. Therefore, all the fiber bundles are in direct contact with the plate-shaped heating member and are uniformly heated, so that property deterioration in EDFs that configure the fiber bundles due to insufficient heating does not occur. As a result, stable optical amplification can be realized in all the fiber bundles.

Although it has been described that the fiber-bundle set 164 is arranged on an upper surface of the plate-shaped heating member 163 in the embodiment descried above, the fiber-bundle set 164 may be sandwiched between two plate-shaped heating members from above and below. This configuration can realize quicker heating of the fiber-bundle set 164, and can shorten the starting time of the temperature retaining structure 160.

Further, an accommodating portion formed by the case member 161 and the cover member 166 may be filled with a resin, for example, while the first heat insulating member 162, the plate-shaped heating member 163, the fiber-bundle set 164, and the second heat insulating member 165 are accommodated in the accommodating portion. With this configuration, displacement of the fiber bundles 164(1) to 164(n) can be surely prevented, and the fiber bundles 164(1) to 164(n) can be heated more uniformly.

According to an aspect of the transmission device and the optical amplifier disclosed in the preset application, there is an effect where stable optical amplification can be realized.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmission device comprising:
an input/output unit that inputs or outputs an optical signal; and
an optical amplifier that amplifies the optical signal passing through an optical fiber by excitation light, wherein
the optical amplifier includes
a fiber-bundle set that includes a plurality of fiber bundles each formed by winding the optical fiber, and
a plate-shaped heating member that has one surface along which the fiber bundles are arranged, and
the fiber bundles have mutually different winding radii and are concentrically arranged on the surface of the plate-shaped heating member.

2. The transmission device according to claim 1, wherein the fiber bundles have mutually different winding radii for each route.

3. The transmission device according to claim 1, further comprising a light source that emits the excitation light with a wavelength for exciting the optical fiber, wherein
the optical amplifier amplifies the optical signal passing through the optical fiber by using the excitation light to be emitted from the light source.

4. An optical amplifier comprising:
a fiber-bundle set that includes a plurality of fiber bundles each formed by winding an optical fiber; and
a plate-shaped heating member that has one surface along which the fiber bundles are arranged, wherein
the fiber bundles have mutually different winding radii and are concentrically arranged on the surface of the place-shaped heating member.

5. The optical amplifier according to claim 4, wherein
the plate-shaped heating member includes
a metal plate, and
a heater that is attached to the metal plate and generates heat, and
the fiber bundles are arranged on a surface of the metal plate opposite to a surface of the metal plate to which the heater is attached.

6. The optical amplifier according to claim 5, wherein
the plate-shaped heating member further includes a temperature measuring element that is arranged on the surface of the metal plate to which the heater is attached, and measures a temperature of the metal plate, and
the heater has an annular shape surrounding the temperature measuring element.

7. The optical amplifier according to claim 4, further comprising a case member that accommodates the plate-shaped heating member and the fiber bundles therein, wherein
the case member has a protrusion that protrudes from a bottom surface thereof to one surface of the plate-shaped heating member through the plate-shaped heating member, and
the fiber bundles include a fiber bundle formed by an optical fiber winding around the protrusion.

8. The optical amplifier according to claim 4, further comprising a pair of heat insulating members that sandwiches the plate-shaped heating member and the fiber bundles therebetween.
